(19) United States
(12) Patent Application Publication
(10) Pub. No.: US 2016/0230434 A1
(43) Pub. Date: Aug. 11, 2016

(54) Lift Stop IIII

(71) Applicant: Francis Gerard Sassone, New Orleans, LA (US)

(72) Inventor: Francis Gerard Sassone, New Orleans, LA (US)

(21) Appl. No.: 14/615,306

(22) Filed: Feb. 5, 2015

(51) Int. Cl. E05C 17/44

(52) U.S. Cl. CPC E05C 17/443

(57) ABSTRACT

The invention LIFT STOP III is a mechanical device that is made to lift a doorstop from its down position to its full up position. The LIFT STOP III is used in conjunction with a doorstop.

### BRIEF SUMMARY

LIFT STOP III will be used to lift any conventional hinged doorstop from the down position off the floor, to an up position, allowing the door to close. LIFT STOP III will allow the user to disengage the doorstop from an erect and standing position, without having to bend over and lift the doorstop with a hand or lift the doorstop with the toe-end of a shoe.

LIFT STOP III is made with an aluminum rod, approximately 1.25 centimeters in diameter. The rod will be attached to a door with three brackets with small hoops, allowing the rod to slide up and down. The top of the rod will have an “L” shape in it, for pulling the rod upward. The rod will be attached to the doorstop by a via the metal “YOKE”, through a hole drilled through the doorstop, that will pull the doorstop upward into its “up” position to allow the door to close.

LIFT STOP III can be installed on any door made of wood or metal.

The process in LIFT STOP III's use is as follows:

A person opens the door and pushes down the doorstop holding the door opened. When they are ready to close the door, they use the “L” shape bend at the top of the rod of the LIFT STOP III, lifting the doorstop back into its upward position, disengaging the doorstop from the floor, hence allowing the door to close.

### DETAILED DESCRIPTION

The LIFT STOP III was designed and manufactured to literally “lift” a doorstop from its down position to its up position without having to bend over to lift it by hand or to “kick” it back up with the toe of a shoe. There is no product or device like this on the market.

The design is a simple rod that is attached to any conventional wooden or metal door with a doorstop already attached to the door or as a complete unit attached to the doorstop. The LIFT STOP III will be sold as a complete unit, with specific, easy to follow instructions on how to install it. Included in the unit will be an aluminum rod that will come in gold or silver already attached at the manufacturer to the door stop, three eye hole mounting brackets to mount the rod to the door and a set of wood and metal screws for each bracket. Wood screws for a wooden door, metal screws for a metal door.

The method of installation is to screw the doorstop to the bottom of the door, then attach the brackets, holding the rod, evenly spaced onto the door.

The LIFT STOP III with the LIFT RING can be used on doors where the doorstop is already attached and in use.

The method of installation: slip the existing door stop through the LIFT RING, then attach the rod to door by using the attached brackets, holding the rod, onto the door.

### DESCRIPTION OF DRAWINGS

FIG. 1A is a front enlargement view of the LIFT STOP III attached to a door with a doorstop. It shows how the Lift Stop III rod is connected to the door with the mounting bracket and how it is attached to the doorstop and is used to pull the doorstop to its “up” position.

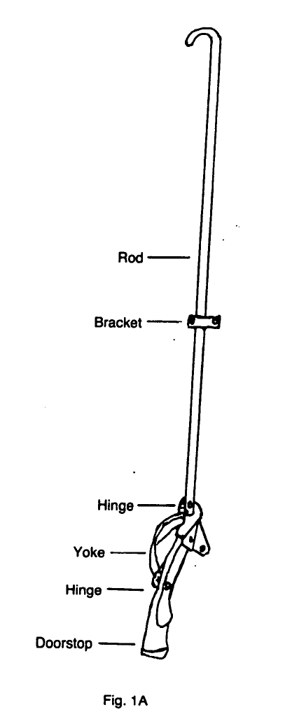

The curved top of the rod is to accommodate a person's index finger in lifting the rod that will in turn, lift the doorstop back into an “up” position, hence allowing the door to close.

FIG. 2A is an enlargement of the LIFT STOP III being used with “existing” doorstops. The “LIFT RING” is slipped over the doorstop, which is connected to the “yoke”, which is connected to the “rod”. All of these are made out of aluminum.

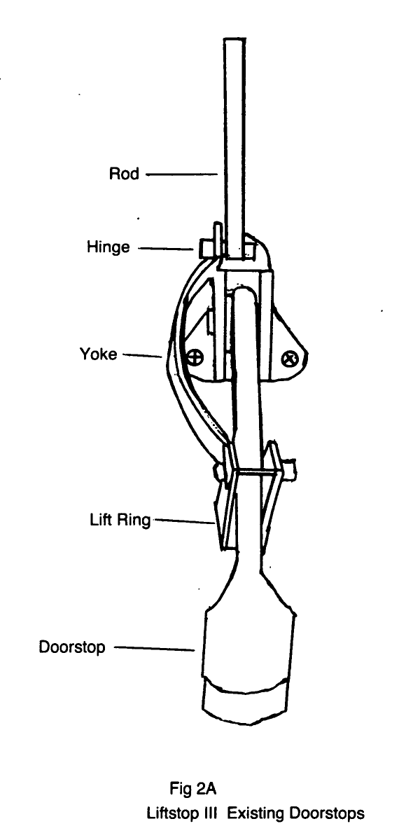

1. The LIFT STOP III device is comprised of an aluminum rod that is mounted to a wooden or metal door with the three “eye” ring brackets that the rod slides up and down in. The top of the rod is bent in an “L” shape to accommodate an index finger or an index finger and thumb to pull the rod upward. The rod is attached to the doorstop by a hinged “YOKE”, that is mounted onto the rod with a hinged pin. This allows the clip to move freely from a horizontal and vertical position as the rod is pulled up and the doorstop is pushed down to hold the door open. The purpose of the LIFT STOP III is to lift the doorstop from its down position without having to bend over or “kick” it up with one's foot, when the door is closed.
